(19) United States
(12) Patent Application Publication
(10) Pub. No.: US 2024/0396176 A1
(43) Pub. Date: Nov. 28, 2024

(54) ELASTIC SHEET FOR ALL SOLID-STATE BATTERY AND ALL SOLID-STATE BATTERY INCLUDING SAME

(71) Applicant: SAMSUNG SDI CO., LTD., Yongin-si (KR)

(72) Inventors: Changhee WOO, Yongin-si (KR); Ik Hwan Cho, Yongin-si (KR); Jiwan You, Yongin-si (KR); Jinhwan Park, Yongin-si (KR)

(21) Appl. No.: 18/638,780

(22) Filed: Apr. 18, 2024

(30) Foreign Application Priority Data
May 24, 2023 (KR) 10-2023-0067183

(51) Int. Cl. H01M 50/486; H01M 50/474; H01M 50/483

(52) U.S. Cl. CPC H01M 50/486; H01M 50/474; H01M 50/483

(57) ABSTRACT

An elastic sheet for an all solid-state battery includes an acryl binder, hollow particles, and a glass filler, wherein the elastic sheet satisfies Equation 1,

$$2 \leq CFD 70 / CFD 50 \leq 4 \qquad [ Equation 1 ]$$

wherein CFD50 is a compressive strength (MPa) measured at a point of about 50% of an initial thickness of the elastic sheet, and CFD70 is a compressive strength (MPa) measured at a point of about 30% of the initial thickness of the elastic sheet.

### CROSS-REFERENCE TO RELATED APPLICATION

This application claims priority to and the benefit of Korean Patent Application No. 10-2023-0067183, filed in the Korean Intellectual Property Office on May 24, 2023, the entire contents of which are incorporated herein by reference.

### BACKGROUND

### 1. Field

Embodiments of this disclosure relates to an elastic sheet for an all solid-state battery and an all solid-state battery including the same.

### 2. Description of the Related Art

Recently, with the rapid spread of electronic devices, e.g., mobile phones, laptop computers, and electric vehicles using batteries, the demand for small, lightweight, and relatively high-capacity rechargeable batteries is rapidly increasing. As such, development of a rechargeable battery, e.g., an all solid-state battery using a lithium metal as a negative electrode, has been progressed.

An all solid-state battery refers to a rechargeable battery in which all materials are solid, e.g., a rechargeable battery using a solid electrolyte. The all solid-state battery is structurally strong because the electrolyte is solid, thereby reducing the risk of fire or explosion due to electrolyte leakage by an external impact, or the like. The battery shape may be formed in various ways.

### SUMMARY

One or more embodiments provide an elastic sheet for an all solid-state battery, including an acryl binder, hollow particles, and a glass filler, wherein the elastic sheet satisfies Equation 1, where CFD50 is a compressive strength (MPa) measured at a point of about 50% of an initial thickness of the elastic sheet, and CFD70 is a compressive strength (MPa) measured at a point of about 30% of the initial thickness of the elastic sheet.

$$2 \leq CFD 70 / CFD 50 \leq 4 \qquad [ Equation 1 ]$$

The CFD50 may equal about 0.5 MPa to about 4 MPa.

The CFD70 may equal about 2 MPa to about 6 MPa.

When the CFD70 and the CFD50 are set to a y-axis and a strain rate of the elastic sheet is set to an x-axis, a slope may be about 4 to about 30.

An amount of the acryl binder may be about 85 wt % to 98.5 wt %, based on 100 wt % of the elastic sheet.

An amount of the hollow particles may be about 0.5 wt % to about 5 wt %, based on 100 wt % of the elastic sheet.

An amount of the glass filler may be about 1 wt % to about 10 wt %, based on 100 wt % of the elastic sheet.

The acryl binder may be a (meth)acryl copolymer.

The (meth)acryl copolymer may be a terpolymer including a first repeating unit derived from a linear alkyl (meth)acrylate having a glass transition temperature of about −30° C. or less, a second repeating unit derived from cyclic alkyl (meth)acrylate having a Tg of about 50° C. or more, and a third repeating unit derived from alkyl (meth)acrylate having a hydroxy group.

The terpolymer may include the first repeating unit in an amount of about 10 wt % to about 40 wt %, the second repeating unit in an amount of about 20 wt % to about 50 wt %, and the third repeating unit in an amount of about 10 wt % to about 50 wt %, based on 100 wt % of the terpolymer.

The hollow particles may be polymer hollow particles.

The polymer hollow particles may include polyacrylonitrile, a polymethylmethacrylate polymer, a silicon-containing polymer, or a combination thereof.

Each of the hollow particles may have a diameter of about 10 μm to about 90 μm.

The glass filler may have a particle diameter of about 10 μm to about 90 μm.

An all solid-state battery may include a positive electrode, a negative electrode, a solid electrolyte between the positive electrode and the negative electrode, and the elastic sheet positioned outside of at least one of the positive electrode and the negative electrode.

### BRIEF DESCRIPTION OF THE DRAWINGS

Features will become apparent to those of skill in the art by describing in detail exemplary embodiments with reference to the attached drawings in which:

FIG. 1 is a schematic diagram schematically showing an all solid-state battery according to one or more embodiments.

FIG. 2 is a cross-sectional view schematically showing an all solid-state battery according to another embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Expressions in the singular include expressions in plural unless the context clearly dictates otherwise. The term “combination thereof may include a mixture, a laminate, a complex, a copolymer, an alloy, a blend, a reactant of constituents.

The term “comprise”, “include” or “have” are intended to designate that the performed characteristics, numbers, step, constituted elements, or a combination thereof is present, but it should be understood that the possibility of presence or addition of one or more other characteristics, numbers, steps, constituted element, or a combination are not to be precluded in advance.

In addition, the terms “about” and “substantially” used throughout the present specification refer to the meaning of the mentioned with inherent preparation and material permissible errors when presented, and are used in the sense of being close to or near that value. They are used to help understand embodiments and to prevent unconscientious infringers from unfairly exploiting the disclosure where accurate or absolute values are mentioned.

In the specification, ┌A and/or B┘ indicates ┌A or B or both of them┘.

In embodiments, “size” or “a particle diameter”, may be an average particle diameter particle. Unless otherwise defined in the specification, the average particle diameter may be defined as an average particle diameter D50 indicating the diameter of particles having a cumulative volume of 50 volume % in the particle size distribution, and may be measured by a PSA (particle size analyzer). The particle size may be measured by a method well known to those skilled in the art, for example, by a particle size analyzer, or by a transmission electron microscopic image, a scanning electron microscopic image), or a field emission scanning electron microscopy (FE-SEM). In another embodiments, a dynamic light-scattering measurement device is used to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Inc.), irradiating ultrasonic waves of about 28 kHz at a power of 60 W, and calculating an average particle diameter (D50) in the 50% standard of particle distribution in the measuring device.

The term “thickness” may be measured through a photograph taken with an optical microscope such as a scanning electron microscope, for example.

One or more embodiments relate to an elastic sheet for an all solid-state battery. Such an elastic sheet may be called a buffer layer or an elasticity layer. The elastic sheet serves to uniformly transfer pressure to an electrode assembly including a negative electrode, a solid electrolyte, and a positive electrode, thereby ensuring good contact with the solid components and also relaxing stress transmitted to the solid electrolyte, or the like. The elastic sheet serves to buffer changes in the thickness of the electrode during charging and discharging.

An elastic sheet for an all solid-state battery according to one or more embodiments includes an acryl binder, hollow particles, and a glass filler. Further, the elastic sheet satisfies Equation 1, below.

$$2 \leq CFD 70 / CFD 50 \leq 4 \qquad [ Equation 1 ]$$

In Equation 1, CFD refers to compression force deflection. Therefore, CFD50 is a compressive strength (MPa) measured at a point of about 50% thickness of a total initial thickness of the elastic sheet, and CFD70 is a compressive strength (MPa) measured at a point of about 30% thickness of the total initial thickness of the elastic sheet.

As such, the CFD50 indicates a compressive strength when the thickness of the elastic sheet is compressed to about 50% of the initial thickness, and it is considered as the maximum compression state which may occur in the all solid-state battery preparation. For example, the CFD50 indicates a compressive strength of the elastic sheet, if the all solid-state battery is fabricated (i.e., during fabrication). The CFD70 is considered as a maximum compression state which may occur if the all solid-state battery is operated, e.g., during charging and discharging. For example, the CFD70 indicates a compressive strength value if the all solid-state battery is charged.

If the elastic sheet satisfies Equation 1, the electrode (i.e., the positive electrode and/or the negative electrode) and the solid electrolyte may be sufficiently adhered to each other, thereby facilitating the smooth movement of lithium. Even though the electrode volume is expanded during charging and discharging, the elastic sheet may effectively absorb (e.g., buffer) this volume change, thereby relaxing (e.g., reducing) impact applied onto the electrode and the solid electrolyte, which in turn, may prevent or substantially minimize damage to the electrode and the solid electrolyte (e.g., prevent or substantially minimize generation of cracks in the electrode and the solid electrolyte). The elastic sheet may help the expanded electrode shrink back to its original thickness, e.g., be restored. Thus, the cycle-life characteristics of the all solid-state battery may be improved and the discharge efficiency may be also improved.

If the elastic sheet has a value expressed by Equation 1 of less than 2, the adherence between the electrode and the solid electrolyte is insufficient. If the elastic sheet has a value expressed by Equation 1 of more than 4, the electrode volume expansion during charging and discharging may not be buffered, thereby causing damage to the electrode and the solid electrolyte.

In one or more embodiments, the CFD50 may be measured under the ASTM D3574 C standard. For example, the elastic sheet is stacked to about 50 mm X about 50 mm X about 20 mm, compressed to a compressive strain of about 50% along the thickness-axis, maintained for about 1 minute to measure a Compression Force Deflection (e.g., refers to a compressive strength when the elastic sheet is compressed to about 50% of the initial thickness). Similarly, the CFD70 indicates a compressive strength when the elastics sheet is compressed to about 30% of the original thickness (e.g., the elastic sheet is compressed by about 70% to about 30% of the initial thickness).

In one or more embodiments, the CFD50 may equal about 0.5 MPa to about 4 MPa, e.g., about 0.8 MPa to about 3 MPa. The CFD70 may be about 2 MPa to about 6 MPa, e.g., about 2.5 MPa to about 5 MPa.

If the CFD50 and the CFD70 are within the above ranges, the internal pressure of the all solid-state battery may be maintained at a suitable level. Thus, damage to the solid electrolyte may be effectively suppressed.

If the values of CFD70 and the CFD50 are set to the y-axis and the elastic sheet thickness strain rate is set to the x-axis, the slope may be about 4 to about 30, e.g., about 5 to about 25.

Hereinafter, the components of the elastic sheet will be described.

### <Acryl Binder>

In one or more embodiments, the acryl binder is a main component of the elastic sheet and may include, e.g., (meth)acryl copolymer exhibiting good stress relaxation characteristic.

An amount of the acryl binder may be about 85 wt % to about 98.5 wt %, e.g., about 87 wt % to about 98.5 wt % or about 90 wt % to about 98 wt %, based on 100 wt % of the elastic sheet. If the amount of the acryl binder is within the above range, the elastic sheet will exhibit excellent stress relaxation characteristics.

The (meth)acryl copolymer may be a terpolymer including a first repeating unit derived from a linear alkyl (meth)acrylate having a glass transition temperature (Tg) of about −30° C. or less, a second repeating unit derived from cyclic alkyl (meth)acrylate having a Tg of about 50° C. or more, and a third repeating unit derived from alkyl (meth)acrylate having a hydroxy group.

In one or more embodiments, (meth)acryl refers to acrylic or methacrylic. For example, 2-ethylhexyl (meth)acrylate indicates 2-ethylhexyl acrylate or 2-ethylhexyl methacrylate.

The linear alkyl (meth)acrylate may have a Tg of about −30° C. or less, e.g., about −30° C. to about −70° C. or about −40° C. to about −60° C. The linear alkyl (meth)acrylate may be, e.g., 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, 2-propyloctyl (meth)acrylate, or a combination thereof.

The cyclic alkyl (meth)acrylate may have a Tg of about 50° C. or more, e.g., about 50° C. to about 80° C. or about 50° C. to about 65° C. The cyclic alkyl (meth)acrylate may be, e.g., isobornyl (meth)acrylate, cyclohexyl (meth)acrylate, cyclopentyl (meth)acrylate, or a combination thereof.

The alkyl (meth)acrylate having a hydroxy group may be, e.g., 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

In one or more embodiments, the acryl binder may be a terpolymer including the first repeating unit, the second repeating unit, and the third repeating unit, and if all of these are included, the stress relaxation characteristics of the elastic sheet may be increased further.

In one or more embodiments, based on the total weight of the terpolymer, the amount of the first repeating unit may be about 10 wt % to about 40 wt %, e.g., about 10 wt % to about 30 wt % or about 10 wt % to about 20 wt %. Based on the total weight of the terpolymer, the amount of the second repeating unit may be about 20 wt % to about 50 wt %, e.g., about 25 wt % to about 50 wt % or about 30 wt % to about 50 wt %. Based on the total weight of the terpolymer, the amount of the third repeating unit may be about 10 wt % to about 50 wt %, e.g., about 10 wt % to about 40 wt % or about 10 wt % to about 35 wt %.

In the terpolymer, if the amounts of the first repeating unit, the second repeating unit, and the third repeating unit are included in the above ranges, the flexibility of the elastic sheet may be better maintained and it may be well adhered to the electrode assembly.

### <Hollow Particles>

The hollow particles according to one or more embodiments may serve to maintain low compressive strength even if the compressibility is increased, and relax impact applied to the electrode and the solid electrolyte, while maintaining the initial compressive strength and well maintaining the compressive function of the elastic sheet. It may give, e.g., impart or form, groove shapes to the elastic sheet.

A hollow particle is a particle of which an inside is empty. The hollow particle may be expressed as a hollow sphere or a hollow bead, e.g., may be a hollow nanoparticle or a hollow micro particle.

The hollow particles may be polymer hollow particles prepared by a polymer. The polymer may be, e.g., polyacrylonitrile, polymethylmethacrylate, a silicon-containing polymer, or a combination thereof. The silicon-containing polymer may be a polymer obtained from, e.g., phenyl silane, propyltrimethoxy silane, ethyltrimethoxy silane, methyltrimethoxy silane, propyltriethoxy silane, vinyltriethoxy silane or methyltriethoxy silane.

The hollow particles may be expanded or non-expanded, e.g., may be expanded at about 120° C. to about 150° C.

The amount of the hollow particles may be about 0.5 wt % to about 5 wt %, e.g., about 0.5 wt % to about 4 wt % or about 0.5 wt % to about 3 wt %, based on 100 wt % of the elastic sheet. If the amount of the hollow particles is within the above range, the initial compressive strength may be better maintained, and increases in the compressive strength may be effectively suppressed, if the compressibility is increased.

Each of the hollow particles may have a size (e.g., a particle diameter) of about 10 μm to about 90 μm, e.g., about 30 μm to about 90 μm, about 35 μm to about 90 μm, about 40 μm to about 90 μm, or about 40 μm to about 80 μm. If the size of each of the hollow particles is within the above range, the initial compressive strength may be better maintained, the impact applied to the electrode and the solid electrolyte may be more effectively relaxed, and it may be suitable compressed.

### <Glass Filler>

In one or more embodiments, the glass filler serves to reduce a density of the elastic sheet, thereby improving a compressive strength. Such a glass filler may include a glass bubble, e.g., glass particles. If the density of the elastic sheet is reduced, the energy capacity may be improved and the elastic sheet does not expand in the plane direction if compressed.

The glass filler may include, e.g., Si, amorphous silica, mesoporous silica, fumed silica, or a combination thereof. The amount of the glass filler may be about 1 wt % to about 10 wt %, e.g., about 1 wt % to about 9 wt %, about 2 wt % to about 8 wt %, about 2 wt % to about 7 wt %, based on 100 wt % of the elastic sheet. If the amount of the glass filler is within the above range, the glass filler may be more uniformly distributed in the elastic sheet, thereby further decreasing the density of the elastic sheet. Thus, the energy capacity may be further improved and the effect for improving the compressive strength may be further increased.

In one or more embodiments, a size (e.g., a particle diameter) of the glass filler (e.g., a size of each of the glass particles) may be about 10 μm to about 90 μm, e.g., about 30 μm to about 90 μm, about 35 μm to about 90 μm, about 40 μm to about 90 μm, or about 40 μm to about 80 μm. If the size of the glass filler is within the above range, the compressive strength may be further improved.

### <Additional Additive>

The elastic sheet according to one or more embodiments may further include suitable additives in addition to the components discussed previously. For example, the additive may be a cross-linking binder (e.g., silica, a polyisocyanate compound, or the like), a tackifier (e.g., terpene, phenol, or the like), or the like. Each additive may be included in a suitable amount according to the purpose.

In one or more embodiments, the thickness of the elastic sheet may be about 100 μm to about 800 μm, e.g., about 100 μm to about 600 μm or about 150 μm to about 500 μm. If the thickness of the elastic sheet is within the above range, stress due to pressurization and stress due to volume change during charging and discharging may be sufficiently relaxed and excellent restoring force may be exhibited.

The elastic sheet according to one or more embodiments may be prepared by adding an initiator to the composition of the elastic sheet including the linear alkyl (meth)acrylate first monomer having a Tg of about −30° C. or less, the cyclic alkyl (meth)acrylate second monomer having a Tg of about 50° C. or more, and the alkyl (meth)acrylate having a hydroxy group third monomer, hollow particles, and a glass filler, and irradiating UV to the resultant mixture.

Irradiation of UV may be carried out by coating the mixture on a release substrate and irradiating UV thereto. The release film may be, e.g., polyethylene terephthalate. Irradiation of the UV may be carried out by using a light quantity of about 1000 mJ/cm² to about 5000 mJ/cm².

The initiator may be a radical-type photopolymerization initiator. The radical-type photopolymerization initiator may, e.g., 1,2-diphenyl-2,2-dimethoxyethanone (Trademark: igacure651 (available from Ciba Specialty Chemicals)), 2-ethylhexyl acrylate, 2-isopropyl thioxanthone (2-isopropyl thioxanthone), polyurethane acrylate, benzophenone, 4-methylbenzophenone, 4,4′-bis(diethylamino)benzophenone, or a combination thereof.

An amount of the initiator may be about 1 part by weight to about 5 parts by weight based on 100 parts by weight of the solid content of the composition for the elastic sheet, e.g., about 0.05 parts by weight to about 3 parts by weight or about 0.1 parts by weight to about 1 part by weight.

A cross-linking agent may be further added to the mixture. The cross-linking agent may be multi-functional (meth)acrylate, e.g., bifunctional acrylate trimethylol propane tri(meth)acrylate such as 1,4-butanediol di(meth)acrylate, 1,6-hexanediol di(meth)acrylate, neopentylglycol di(meth)acrylate, polyethyleneglycol di(meth)acrylate, neopentylglycol adipate (neopentylglycol adipate) di(meth)acrylate, dicyclopentanyl) di(meth)acrylate, caprolactone modified dicyclopentenyl di(meth)acrylate, ethylene oxide modified di(meth)acrylate, di(meth)acryloxyethyl isocyanurate, allylation cyclohexyl di(meth)acrylate, tricyclodecanedimethanol (meth)acrylate, dimethylol dicyclopentane di(meth)acrylate, ethyleneoxide modified hexahydrophthalic acid di(meth)acrylate, tricyclodecane dimethanol (meth)acrylate, neopentyl glycol modified trimethylpropane di(meth)acrylate, adamantane di(meth)acrylate or 9,9-bis [4-(2-acryloyloxyethoxy)phenyl]fluorene, or the like; trifunctional acrylate diglycerine tetra(meth)acrylate such as dipentaerythritol tri(meth)acrylate, propionic acid modified dipentaerythritol tri(meth)acrylate, pentaerythritol tri(meth)acrylate, propyleneoxide modified trimethylolpropane tri(meth)acrylate, trifunctional urethane (meth)acrylate or tris(meth)acryloxy ethylisocyanurate, or the like, tetrafunctional acrylate such as pentaerythritoltetra(meth)acrylate, pentafunctional acrylate such as dipentaerythritol penta(meth)acrylate, or the like, or hexafunctional acrylate such as dipentaerythritol hexa(meth)acrylate, caprolactone modified dipentaerythritol hexa(meth)acrylate, or the like, but it is not limited thereto. These may be used alone or in a mixture of two or more types.

The cross-linking agent may be included in an amount of about 0.001 parts by weight to about 1 part by weight, e.g., about 0.03 parts by weight to about 0.7 parts by weight or about 0.1 parts by weight to about 0.5 parts by weight, based on 100 parts by weight of the solid content of the composition for the elastic sheet.

### [All Solid-State Battery]

Another embodiment provides an all solid-state battery including the elastic sheet. The all solid-state battery may include a positive electrode, a negative electrode, a solid electrolyte between the positive electrode and the negative electrode, and the elastic sheet positioned outside of at least one of the positive electrode and the negative electrode.

The elastic sheet may be positioned on the outermost layer of an electrode assembly or may be also positioned on the outermost layer and/or inside the assembly in the structure in which at least two electrode assemblies are stacked. Considering that the thickness of the negative electrode is significantly changed due to formation of dendrite, or the like during charge and discharge, the elastic sheet is positioned on the outside of the negative electrode, e.g., on the opposite side of the surface where the solid electrolyte layer is in contact with the negative electrode, thereby serving as a buffer during the thickness changes. The elastic sheet may prevent or substantially minimize deterioration caused by the reaction with lithium by being positioned the outside of the positive electrode and/or the negative electrode, so that the coulomb efficiency may be also enhanced.

The positive electrode may include a positive current collector and a positive active material layer on the positive current collector.

### <Positive Electrode>

The positive active material layer may include a positive active material and a sulfide solid electrolyte. The positive active material layer may further include a binder and a conductive material. The positive active material may include compounds that reversibly intercalate and deintercalate lithium ions.

For example, the positive active material may include one or more composite oxides of a metal selected from cobalt, manganese, nickel, and a combination thereof, and lithium. Examples of the positive active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≥0.5, 0≤c≤05); LiₐNi_{1-b-c}Co_{b}B¹_{c}D¹ₐ (0.90≤a≤1.8, 0≤b≥0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0≤a≤2); LiₐNi_{1-b-c}Mn_{b}B¹_{c}CO_{2-α}F¹_{α} (0.90≤a≤1.8, 0≤b≤0.5, 0≤α≤0.5, 0<α<2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂ (PO₄)₃ (0≤f≤2); Li_{(3-f)}Fe₂ (PO₄)₃ (0≤f≤2); or LiFePO₄.

In the chemical formulas above, A is selected from Ni, Co, Mn, or a combination thereof; B¹ is selected from Al, Ni, Co, Mn, Cr, Fe, Mg, Sr, V, a rare earth element, or a combination thereof; D¹ is selected from O, F, S, P, or combination thereof; E is selected from Co, Mn, or combination thereof; F¹ is selected from F, S, P, or a combination thereof; G is selected from Al, Cr, Mn, Fe, Mg, La, Ce, Sr, V, or a combination thereof; Q is selected from Ti, Mo, Mn, or a combination thereof; I¹ is selected from Cr, V, Fe, Sc, Y, or a combination thereof; J is selected from V, Cr, Mn, Co, Ni, Cu, or a combination thereof; L¹ is selected from Mn, Al, or a combination thereof.

The compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include, e.g., Mg, Al, Co, K, Na, Ca, Si, Ti, V, Sn, Ge, Ga, B, As, Zr, or mixture thereof.

Furthermore, the coating layer may be any coating materials which are known as a coating layer for the positive active material of the all solid battery, e.g., LizO-ZrO₂ (LZO), and the like.

If the positive active material is three-components including nickel, cobalt, and manganese, or nickel, cobalt, and aluminum, the capacity density of the all solid-state battery may be further improved, and the metal elution from the positive active material at charged state may be further reduced. This may further improve long reliability and cycle characteristics at a charged state.

The shape of the positive active material may be, e.g., a spherical shape, an ellipsoidal shape, a shape close to spherical, or a particle shape such as polyhedron, or unspecified shape, or the like.

The average particle diameter of the positive active material may not be limited, and may be in any range which may be applied to a positive active material of the conventional all solid-state secondary battery. For example, an average particle diameter of the positive active material may be about 1 μm to about 25 μm, e.g., about 4 μm to about 25 μm, about 5 to μm to about 20 μm, about 8 μm to about 20 μm, or about 10 μm to about 18 μm. The positive active material with the particle diameter range may be harmoniously mixed with other components in the positive active material layer and may achieve high-capacity and high energy density.

The positive active material may include secondary particle where a plurality of primary particles is agglomerated, or monocrystalline (single crystal).

In the positive active material layer, an amount of the positive active material may be about 55 wt % to about 99.7 wt %, e.g., about 74 wt % to about 89.8 wt %, based on 100 wt % of the positive active material layer. Inclusion in the range may maximize the capacity of the all solid-state battery and may further improve cycle-life characteristic.

In one or more embodiments, the sulfide solid electrolyte may be Li₂S—P₂S₅, Li₂S—P₂S₅—LiX (where X is an halogen element, for example, I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each an integer of about 0 or more and about 12 or less, Z is Ge, Zn, or Ga) Li₂S—GeS₂, Li₂S—SiS₂—Li₃PO₄, Li₂S—SiS₂-LiₚMO_{q} (where p and q are each an integer of about 0 or more and about 12 or less, and M is P, Si, Ge, B, Al, Ga, or In), LiₐM_{b}P_{c}S_{d}Aₑ (where a, b, c, d, and e are each an integer of about 0 or more and about 12 or less, M is Ge, Sn, Si, or a combination thereof, and A is F, Cl, Br, or I). The sulfide solid electrolyte may be, for example, Li₇₋ₓPS₆₋ₓFₓ (0≤x≤2), Li₇₋ₓPS₆₋ₓClₓ (0≤x≤2), Li₇₋ₓPS₆₋ₓBrₓ (0≤x≤2) or Li₇₋ₓPS₆₋ₓIₓ (0≤x≤2). In some embodiments, it may be Li₃PS₄, Li₇P₃S₁₁, Li₇PS₆, Li₆PS₅Cl, Li₆PS₅Cl, Li₆PS₅I, Li₆PS₅Br, Li_{5.8}PS_{4.8}Cl_{1.2}, Li_{6.2}PS_{5.2}Br_{0.8} or the like.

In one or more embodiments, the sulfide solid electrolyte may be an argyrodite-type sulfide solid electrolyte. The argyrodite-type sulfide solid electrolyte may include, e.g., LiₐM_{b}P_{c}S_{D}Aₑ (where a, b, c, d, and e are each an integer of about 0 or more and about 12 or less, Mis Ge, Sₙ, Si, or a combination thereof, and A is F, Cl, Br, or I). Examples of the sulfide solid electrolyte may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li₆PS₅I, Li_{5.75}PS_{4.75}Cl_{1.25}, (Li_{5.69}Cu_{0.06}) PS_{4.75}Cl_{1.25}, (Li_{5.72}Cu_{0.03}) PS_{4.75}Cl_{1.25}, (Li_{5.69}Cu_{0.06})P (S_{4.70} SO_{40.05})Cl_{1.25}, (Li_{5.69}Cu_{0.06})P (S_{4.60} SO_{40.15})Cl_{1.25}, (Li_{5.72}Cu_{0.03})P (S_{4.725} SO_{40.025}) Cl_{1.25}, (Li_{5.72}Na_{0.03})P (S_{4.725} SO_{40.025})Cl_{1.25}, Li_{5.75}P (S_{4.725} SO_{40.025})Cl_{1.25}, or a combination thereof.

The sulfide solid electrolyte may be amorphous, crystalline, or a combination thereof. The sulfide solid electrolyte may be prepared, e.g., by mixing Li₂S and P₂S₅ at a mole ratio of about 50:50 to about 90:10, e.g., about 50:50 to about 80:20. In the mixing ratio, the sulfide solid electrolyte exhibiting excellent ionic conductivity may be prepared. As other components, SiS₂, GeS₂, B²S₃, or the like may be further included thereto, thereby further improving ionic conductivity.

The mixing procedure of the sulfur-included source for preparing the sulfide solid electrolyte may be performed by a mechanical milling or a solution method. The mechanical milling may be performed by adding starting raw material, a ball mill, or the like in a reactor and vigorously stirring to pulverize the starting raw material and to mix them together. The solution method may provide a solid electrolyte as a precipitate by mixing starting sources in a solvent. If the heat treatment is performed after mixing, the crystal of the solid electrolyte may be further solidified and ionic conductivity may be further improved. For example, the sulfide solid electrolyte may be prepared by mixing sulfur-included raw materials and heat-treating them twice or more, which may provide a sulfide solid electrolyte with high ionic conductivity and rigidity. The sulfide solid electrolyte may be a commercial solid electrolyte.

Based on the total weight of the positive active material layer, an amount of the solid electrolyte may be about 0.1 wt % to about 35 wt %, e.g., about 1 wt % to about 35 wt %, about 5 wt % to about 30 wt %, about 8 wt % to about 25 wt %, or about 10 wt % to about 20 wt %. In the positive active material layer, based on the total weight of the positive active material and the solid electrolyte, the positive active material may be in an amount of about 65 wt % to about 99 wt %, e.g., about 80 wt % to about 90 wt %, and the solid electrolyte of may be in an amount of about 1 wt % to about 35 wt %, e.g., about 10 wt % to about 20 wt %. If the amount of solid electrolyte in the above range is included in the positive electrode, the efficiency and cycle-life characteristic of the all solid-state battery may be improved, without deterioration of capacity.

The binder improves binding properties of positive active material particles with one another and with the current collector. The binder may be polyvinyl alcohol, carboxymethyl cellulose, hydroxypropyl cellulose, diacetyl cellulose, polyvinyl chloride, carboxylated polyvinylchloride, polyvinyl fluoride, an ethylene oxide-containing polymer, polyvinyl pyrrolidone, polyurethane, polytetrafluoroethylene, polyvinylidene fluoride, polyvinylidene fluoride-hexafluoropropylene, polyethylene, polypropylene, a styrene butadiene rubber, an acrylated styrene butadiene rubber, an epoxy resin, nylon, or the like.

The binder may be included in an amount of about 0.1 wt % to about 5 wt %, e.g., about 0.1 wt % to about 3 wt %, based on 100 wt % of the positive active material layer. In the above amount range, the adhesion ability may be sufficiently secured without deteriorating the battery performance.

The conductive material is included to provide electrode conductivity. Any electrically conductive material may be used as a conductive material unless it causes a chemical change. Examples of the conductive material may include a carbon material, e.g., natural graphite, artificial graphite, carbon black, acetylene black, ketjen black, carbon fiber, carbon nanofiber, carbon nanotube and the like; a metal material of a metal powder or a metal fiber including, e.g., copper, nickel, aluminum, silver, and the like; a conductive polymer, e.g., polyphenylene derivatives; or mixtures thereof.

The conductive material may be included in an amount of about 0.1 wt % to about 5 wt %, e.g., about 0.1 wt % to about 3 wt %, based on 100 wt % of the positive active material layer. The conductive material in the above range may improve the electrical conductivity without deteriorating battery performance.

The positive active material layer may have a thickness of about 90 μm to about 200 μm. For example, the thickness of the positive active material layer may be about 90 μm or more, about 100 μm or more, about 110 μm or more, about 120 μm or more, about 130 μm or more, about 140 μm or more, about 150 μm or more, about 160 μm or more, about 170 μm or more, about 180 μm or more, or about 190 μm or more, and about 200 μm or less, about 190 μm or less, about 180 μm or less, about 170 μm or less, about 160 μm or less, about 150 μm or less, about 140 μm or less, about 130 μm or less, about 120 μm or less, or about 110 μm or less.

The positive current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

### <Negative Electrode>

The negative electrode may include a current collector and a negative electrode layer on the current collector.

The negative electrode layer may include a negative electrode coating layer, and the negative electrode coating layer may be a lithium electrodeposition induced layer or a negative catalyst layer.

If the negative electrode layer is the negative electrode coating layer, the negative electrode is referred as a deposition-type negative electrode. The deposition-type negative electrode does not include a negative active material in a preparation of the battery assembly, but lithium metal or the like is deposited to serve it as the negative active material during charging of the battery. To explain this in more detail, during charging an all solid-state battery, lithium ions are released from a positive active material and pass through the solid electrolyte to move to the negative electrode, and thus, it is deposited on the negative current collector so that a lithium-containing layer, e.g., a lithium deposition layer between the current collector and a negative layer, may be formed. The negative electrode with the lithium-containing layer is called the deposition-layer negative electrode. For example, the lithium-containing layer may be formed between the negative current collector and the negative electrode layer.

The charging may be a formation process which may be performed at 0.05° C. to 1° C. at about 25° C. to about 50° C. once to three times.

The lithium-containing layer may have a thickness of about 10 μm to about 50 μm. For example, the thickness of the lithium-containing layer may be about 10 μm or more, about 20 μm or more, about 30 μm or more, or about 40 μm or more, and about 50 μm or less, about 40 μm less, about 30 μm less, or about 20 μm less. If the thickness of the lithium-containing layer is in the above range, the lithium is reversibly deposited during charge and discharge, thereby further improving the cycle-life characteristics.

The negative electrode coating layer may include, e.g., a metal, a carbon material, or combinations thereof, serving as a catalyst. In the negative electrode coating layer, e.g., a metal which is supported on a carbonaceous material may be presented, or a metal mixed with a carbonaceous material may be present. In one or more embodiment, the negative electrode coating layer may include the metal and the carbonaceous material.

The carbonaceous material may be, e.g., crystalline carbon, amorphous carbon, or a combination thereof, and in some embodiments, may be amorphous carbon. The crystalline carbon may be, e.g., natural graphite, artificial graphite, mesophase carbon microbead, or a combination thereof.

The amorphous carbon may be, e.g., carbon black, acetylene black, denka black, ketjen black, furnace black, activated carbon, graphene, or combinations thereof. The carbon black may be Super P (available from Timcal, Ltd.). The amorphous carbon is not limited thereto, and any material which may be classified as amorphous carbon in the field may be available.

The amorphous carbon may include single particles, a secondary particle in which a plurality of primary particles are agglomerated, or combinations thereof.

The single particles may have a particle diameter of about 10 nm to about 60 μm. In another embodiments, a particle diameter of the primary particles may be about 20 nm to about 100 nm, and a particle diameter of the secondary particle may be about 1 μm to about 20 μm.

In some embodiments, a particle diameter of the primary particles may be about 20 nm or more, about 30 nm or more, about 40 nm or more, about 50 nm or more, about 60 nm or more, about 70 nm or more, about 80 nm or more, or about 90 nm or more, and about 100 nm or less, about 90 nm or less, about 80 nm or less, about 70 nm or less, about 60 nm or less, about 50 nm or less, about 40 nm or less, or about 30 nm or less.

In some embodiments, a particle diameter of the secondary particle may be about 1 μm or more, about 3 μm or more, about 5 μm or more, about 7 μm or more, about 10 μm or more, or about 15 μm or more, and about 20 μm or less, about 15 μm or less, about 10 μm or less, about 7 μm or less, about 5 μm or less, or about 3 μm or less.

The shape of the primary particle may be spherical, oval, plate-shaped, or combinations thereof, and in some embodiments, the shape of the primary particle may be spherical, oval, or combinations thereof.

The metal may be at least one selected from Ag, Zn, Al, Sn, Mg, Ge, Cu, In, Ni, Bi, Au, Si, Pt, Pd, or a combination thereof, and in some embodiments, may be Ag. The inclusion of the metal in the negative electrode coating layer may further improve the electrical conductivity of the negative electrode.

The metal particle may have a size (e.g., a diameter) of about 5 nm to about 800 nm. The size of the metal particle may be about 5 nm or more, about 50 nm or more, about 100 nm or more, about 150 nm or more, about 200 nm or more, about 250 nm or more, about 300 nm or more, about 350 nm or more, about 400 nm or more, about 450 nm or more, about 500 nm or more, 550 nm or more, 600 nm or more, 650 nm or more, 700 nm or more, or 750 nm or more. The size of the metal particle may be about 800 nm or less, about 750 nm or less, about 700 nm or less, about 650 nm or less, about 600 nm or less, about 550 nm or less, about 500 nm or less, about 450 nm or less, about 400 nm or less, about 350 nm or less, about 300 nm or less, about 250 nm or less, about 200 nm or less, about 150 nm or less, about 100 nm or less, or about 50 nm or less. If the size of the metal particle is within the above range, the battery characteristics, e.g., cycle-life characteristics of the all solid-state battery, may be improved.

If the negative catalyst layer includes the carbon material and the metal particles, a mixing ratio of the carbon material and the metal particles may be about 1:1 to about 99:1 by weight ratio. For example, an amount of the carbonaceous material may be, based on the metal particle, about 1 or more, about 2 or more, about 3 or more, about 4 or more, about 5 or more, about 10 or more, about 15 or more, about 20 or more, about 25 or more, about 30 or more, about 35 or more, about 40 or more, about 45 or more, about 50 or more, about 55 or more, about 60 or more, about 65 or more, about 70 or more, about 75 or more, about 80 or more, about 85 or more, about 90 or more or about 95 or more, and about 99 or less, about 95 or less, about 90 or less, about 85 or less, about 80 or less, about 75 or less, about 70 or less, about 65 or less, about 60 or less, about 55 or less, about 50 or less, about 45 or less, about 40 or less, about 35 or less, about 30 or less, about 25 or less, about 20 or less, about 15 or less, about 10 or less, about 5 or less, about 4 or less, about 3 or less or about 2 or less. For example, the weight ratio of the carbon material and the metal particles may be about 1:1 to about 5:1, about 1:1 to about 10:1, about 1:1 to about 20:1, about 1:1 to about 25:1, about 1:1 to about 30:1, about 1:1 to about 40:1, about 1:1 to about 50:1, about 1:1 to about 60:1, about 1:1 to about 70:1, about 1:1 to about 80:1, or about 1:1 to about 90:1. If the weight ratio of the carbon material and the metal particles is within the above range, the electrical conductivity of the negative electrode may be further improved.

If the negative electrode layer is the negative electrode coating layer, the current collector may include, e.g., indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may have a foil shape or a sheet shape.

The negative electrode coating layer may further include a binder. The binder may be a non-aqueous binder, an aqueous binder, or combination thereof.

The non-aqueous binder may include, e.g., polyvinyl chloride, carboxylated polyvinyl chloride, polyvinyl fluoride, polyethylene oxide, an ethylene propylene copolymer, polystyrene, polyvinyl pyrrolidone, polyurethane, polytetrafluoroethylene, polyvinylidene fluoride, polyethylene, polypropylene, polyamide imide, polyimides, polyacrylate, or a combination thereof.

The aqueous binder may include, e.g., a styrene-butadiene rubber, an acrylated styrene-butadiene rubber, an acrylonitrile-butadiene rubber, polyvinyl alcohol, polyethylene oxide, polyvinyl pyrrolidone, polyepichlorohydrin, polyphosphazene, polyacrylonitrile, an ethylene propylene diene copolymer, polyvinyl pyridine, chlorosulfonated polyethylene, latex, a polyester resin, an acrylic resin, a phenolic resin, an epoxy resin, an acrylic rubber, a butyl rubber, a fluorine rubber, or a combination thereof.

The binder may further include a cellulose compound. The binder may include the aqueous binder together with the cellulose compound. The cellulose compound may include one or more of, e.g., carboxymethyl cellulose, hydroxypropylmethyl cellulose, methyl cellulose, or alkali metal salts thereof. The alkali metal may be Na, K, or Li. The cellulose compound may serve not only as a binder but also as a thickener that imparts viscosity. Any suitable binder and amounts thereof may be used and adjusted.

The negative electrode coating layer may further include a solid electrolyte, and the solid electrolyte may include the sulfide solid electrolyte previously described with respect to the positive electrode. The solid electrolyte included in the negative electrode may be the same to or different from the solid electrolyte included in the positive electrode.

The negative electrode coating layer may further include, e.g., additives such as a filler, a dispersing agent, an ionic conductive material, and the like. Any suitable filler, dispersing agent, and ionic conductive material may be used in the negative electrode coating layer of the all solid-state battery.

For example, the negative electrode coating layer may have a thickness of about 1 μm to about 500 μm, e.g., about 1 μm to about 200 μm, about 1 μm to about 100 μm, or about 1 μm to about 50 μm, but is not limited thereto.

In one or more embodiments, the negative electrode layer may be a negative active material layer. The negative active material layer may include a negative active material, a binder, and may further include a conductive material.

The negative active material may include lithium metal. If the negative active material includes lithium metal, it may include lithium metal itself, or may include a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy, or the like.

The negative active material may include a material capable of reversibly intercalating/deintercalating lithium-ion, a lithium metal, an alloy of lithium metal, a material capable of doping and dedoping lithium, or a transition metal oxide.

For example, the material capable of reversibly intercalating/deintercalating the lithium-ion may include a carbon negative active material, e.g., may be crystalline carbon, amorphous carbon, or a combination thereof. The crystalline carbon may be graphite, e.g., unspecified shape, sheet, flake, spherical or fiber shaped natural graphite or artificial graphite, and the amorphous carbon may be, e.g., soft carbon, hard carbon, mesophase pitch carbide, sintered cokes, and the like.

For example, lithium metal alloy may include lithium metal and at least one of, e.g., Na, K, Rb, Cs, Fr, Be, Mg, Ca, Sr, Si, Sb, Pb, In, Zn, Ba, Ra, Ge, Al, and Sₙ.

Examples of the material capable of doping and dedoping lithium may include a Si negative active material or a Sₙ active material. The Si negative active material may include, e.g., Si, Si—C composite, SiOx (0<x<2), Si-Q alloys (where Q is selected from alkali metals, alkali-earth metals, group 13 elements, group 14 elements, group 15 elements, group 16 elements, transition metals, rare earth elements, and combination thereof, but Q is not Si). The Sn negative active material may include, e.g., Sn, SnO2, and Sn—R (where R is selected from alkali metal, alkaline earth metals, group 13 elements, group 14 elements, group 15 elements, group 16 elements, transition metals, rare earth elements, and combinations thereof, but R is not Sn), or the like. At least one of these materials may be mixed with SiO2. The elements Q and R may be independently selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

The silicon-carbon composite may be a composite of silicon and amorphous carbon. The silicon-carbon composite may have an average particle diameter D₅₀, e.g., of about 0.5 μm to about 20 μm. According to one or more embodiments, the Si—C composite may include silicon particles and an amorphous carbon coated on the surface of the silicon particles. For example, the Si—C composite may include secondary particles (core) where silicon primary particles are agglomerated, and an amorphous carbon coating layer (shell) on the surface of the secondary particles. For example, the amorphous carbon may be positioned between the silicon primary particles, so that the silicon primary particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be, e.g., artificial graphite, natural graphite or combination thereof. The amorphous carbon may be, e.g., soft carbon, hard carbon, mesophase pitch carbide, sintered cokes, or the like.

If the silicon-carbon composite includes silicon and amorphous carbon, an amount of silicon may be about 10 wt % to about 50 wt %, based on 100 wt % of the silicon-carbon composite, and an amount of the amorphous carbon may be about 50 wt % to about 90 wt %, based on 100 wt % of the silicon-carbon composite. If the composite includes silicon, amorphous carbon, and crystalline carbon, based on 100 wt % of the silicon-carbon composite, an amount of silicon may be about 10 wt % to about 50 wt %, an amount of the crystalline carbon may be about 10 wt % to about 70 wt %, and an amount of the amorphous carbon may be about 20 wt % to about 40 wt %.

The amorphous carbon coating layer may have a thickness of about 5 nm to about 100 nm. An average particle diameter (D₅₀) of the silicon particle (primary particle) may be about 10 nm to about 1 μm, e.g., about 10 nm to about 200 nm. The silicon particle may be, e.g., elemental silicon, a silicon alloy, or an oxidized form. The oxidized silicon may be represented by SiOx (0<x<2). An atomic weight ratio of Si:O representing a degree of oxidation may be about 99:1 to about 33:67. As used herein, an average particle diameter D50 indicates a diameter of particle where the cumulative volume corresponds to about 50 volume % in the particle size distribution.

The Si negative active material or the Sn negative active material may be mixed with the carbon negative active material to use. If the Si negative active material or the Sn negative active material is used together with the carbon active material, a mixing ratio may be a weight ratio of about 1:99 to about 90:10.

In the negative active material layer, an amount of the negative active material may be about 95 wt % to about 99 wt %, based on the total weight of the negative active material layer.

In the negative active material layer, an amount of the binder may be about 1 wt % to about 5 wt %, based on the total weight of the negative active material layer. In case of further including a conductive material, the negative active material may be included at an amount of about 90 wt % to about 98 wt %, the binder may be included at an amount of about 1 wt % to about 5 wt %, and the conductive material may be included at an amount of about 1 wt % to about 5 wt %, based on the total weight of the negative active material layer.

The binder improves binding properties of negative active material particles with one another and with the current collector. The binder may be a non-aqueous binder, an aqueous binder, or combination thereof.

The non-aqueous binder may be an polyvinyl chloride, an carboxylated polyvinyl chloride, polyvinyl fluoride, an ethylene propylene copolymer, polystyrene, polyvinyl pyrrolidone, polyurethane, polytetrafluoroethylene, polyvinylidene fluoride, polyethylene, polypropylene, polyamide imide, polyimides, or combinations thereof.

The aqueous binder may be a styrene-butadiene rubber, an acrylated styrene-butadiene rubber, an acrylonitrile-butadiene rubber, an acrylic rubber, a butyl rubber, a fluorine rubber, polyethylene oxide, polyvinyl pyrrolidone, polyepichlorohydrin, polyphosphazene, polyacrylonitrile, ethylene propylenediene copolymer, polyvinyl pyridine, chlorosulfonated polyethylene, latex, a polyester resin, an acrylic resin, a phenolic resin, an epoxy resin, polyvinyl alcohol, or combinations thereof.

The negative active material layer may include a cellulose compound. The cellulose compound includes one or more of carboxymethyl cellulose, hydroxypropylmethyl cellulose, methyl cellulose, or alkali metal salts thereof. The alkali metal may be Na, K, or Li. The cellulose compound may serve as a binder and serve as a thickener to impart viscosity. An amount of the cellulose compound may be not limited, but, for example, the amount of the cellulose compound may be about 0.1 parts by weight to about 3 parts by weight based on 100 parts by weight of the negative active material.

If the negative electrode layer is the negative active material layer, the current collector may include one selected from a copper foil, a nickel foil, a stainless steel foil, a titanium foil, a nickel foam, a copper foam, a polymer substrate coated with a conductive metal, and a combination thereof.

### <Solid Electrolyte Layer>

The solid electrolyte layer may include a solid electrolyte. The solid electrolyte may be an inorganic solid electrolyte, e.g., a sulfide solid electrolyte, an oxide solid electrolyte, a halide solid electrolyte, and the like, or solid polymer electrolyte.

The sulfide solid electrolyte is as described above, and may be the same as or different from the solid electrolyte included in the positive electrode or the negative electrode.

The oxide inorganic solid electrolyte may be, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃(PMN-PT), HfO₂, SrTiO₃, SnO₂, CeO₂, NazO, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (M=Te, Nb, or Zr; x is an integer of about 1 to about 10), or mixtures thereof.

The halide solid electrolyte may include, e.g., a Li element, a M element (where M is a metal except for Li), and a X element (where X is a halogen). The X may be, for example, F, Cl, Br and I. In some embodiments, the halide solid electrolyte may include, e.g., at least one of Br and Cl, as the X. The M may be, e.g., metal element such as Sc, Y, B, Al, Ga, In, and the like.

The composition of the halide solid electrolyte may be represented by Li₆₋₃ₐMₐBr_{b}Cl_{c} (where, M is a metal, except for Li, 0<a<2, 0≤b≤6, 0≤c≤6, b+c=6). The a may be about 0.75 or more, e.g., about 1 or more, and the a may be about 1.5 or less. The b may be about 1 or more, e.g., about 2 or more. The c may be about 3 or more, e.g., about 4 or more. Examples of the halide solid electrolyte may include Li₃YBr₆, Li₃YCl₆ or Li₃YBr₂Cl₄.

The solid electrolyte layer may further include a binder. The binder may be, e.g., a styrene butadiene rubber, polytetrafluoroethylene, polyvinylidene fluoride, polyethylene, an acrylate polymer, or a combination thereof, and may be any material which is generally used in the related art. The acrylate polymer may be, e.g., butyl acrylate, polyacrylate, polymethacrylate, or combinations thereof.

The solid electrolyte layer may be prepared by adding the solid electrolyte to a binder solution, coating it on a substrate film, and drying it. The binder solution may include, e.g., isobutylyl isobutylate, xylene, toluene, benzene, hexane, or combinations thereof. The solid electrolyte layer may have a thickness of about 10 μm to about 150 μm.

The solid electrolyte layer may further include an alkali metal salt, and/or an ionic liquid, and/or a conductive polymer.

The alkali metal salt may be, e.g., a lithium salt. In the solid electrolyte layer, an amount of the lithium salt may be about 1 M or more, e.g., about 1 M to about 4 M. The lithium salt in the above amount may improve the lithium ion mobility in the solid electrolyte layer, thereby improving ionic conductivity.

The lithium salt may be, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂), lithium bis(fluorosulfonyl) imide, LiFSI, LIN (SO₂F)₂), LiCF₃SO₃, LiAsF₆, LiSbF₆, LiClO₄, or a mixture thereof.

The lithium salt may be an imide lithium salt, e.g., lithium bis(trifluoro methanesulfonyl)imide (LiTFSI, LiN(SO₂CF₃)₂), lithium bis(fluorosulfonyl) imide (LiFSI, or LiN(SO₂F)₂), and the like. The lithium salt may suitably maintain the chemical reactivity with the ionic liquid, and thus, the ionic conductivity may be maintained or improved.

The ionic liquid may have a melting point of a room temperature or less which may be a liquid state at a room temperature and salts consisting of only ion, or a room-temperature molten salt.

The ionic liquid may be a compound including at least one cation, e.g., selected from ammonium, pyrroleridinium, pyridinium, pyrrimidinuim, imidazolium, piperidinum, pyrazolium, oxazolium, pyridazium, phosphonium, sulfonium, triazolium, or mixture thereof, and at least one anion, e.g., selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, FSO₂₂N⁻, (C₂F₅SO₂)₂N⁻, (C₂F₅SO₂) (CF₃SO₂)N⁻, or (CF₃SO₂)₂N⁻. The ionic liquid may be, e.g., at least one selected from N-methyl-N-propylpyrroledinium bis(trifluoromethanesulfonyl) imide N-butyl-N-methylpyrroleridinium bis(3-trifluoromethylsulfonyl)imide, 1-butyl-3-methylimidazoleium bis(trifluoromethylsulfonyl) amide, 1-ethyl-3-methylimidazoleium, or bis(trifluoromethylsulfonyl) amide.

In the solid electrolyte layer, the weight ratio of the solid electrolyte and the ionic liquid may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer within the above range may have an improved electrochemical contact area to the electrode, and thus, the ionic conductivity may be maintained or improved. This may improve the energy density, discharge capacity, rate capability, or the like of the all solid-state battery may be improved.

The all solid-state battery according to one or more embodiments may be fabricated by sequentially stacking the positive electrode, the solid electrolyte, and the negative electrode to a laminate, adhering the elastic sheet to the outer surface of the positive electrode and/or the negative electrode, and pressurizing it. For example, the pressurization may be carried out at a temperature of about 25° C. to about 90° C. and under a pressure of about 550 MPa or less, e.g., about 500 MPa or less or about 1 MPa to about 500 MPa. The pressurization time may be varied depending on temperature and pressure, e.g., less than about 30 minutes. The pressurization may be, e.g., isostatic press, warm isostatic press, roll press, or plate press.

In such pressurization conditions, the elastic sheet may be compressed at an appropriate ratio of about 30% to about 70% relative to the initial thickness and the recovery ratio of the elastic sheet may satisfy a ratio of about 60% to about 90% relative to the initial thickness.

The all solid-state battery may be a unit battery including a structure of positive electrode/solid electrolyte layer/negative electrode, a bicell including a structure of positive electrode/solid electrolyte layer/negative electrode/solid electrolyte layer/positive electrode, or a stacked battery where the unit batteries are repeated.

The shape of the all solid-state battery may include, e.g., a coin-type, a button-type, a sheet-type, a laminate-type, a cylindrical-type, or a flat-type, or the like. The all solid-state battery may be applied to medium-to-large batteries used in electric vehicles. For example, the all solid-state battery may be used in hybrid vehicles, e.g., a plug-in hybrid electric vehicle (PHEV), or the like, energy storage systems (ESS) that requires large amounts of electric power, and electric bicycles or power tools.

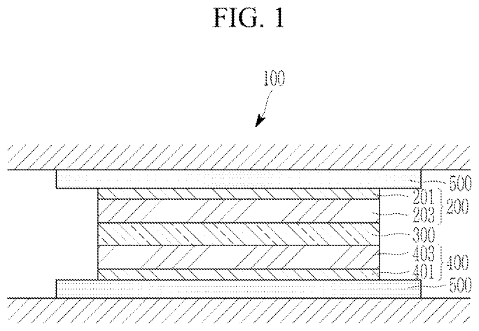

FIG. 1 is a cross-sectional view of an all solid-state battery 100 according to embodiments. Referring to FIG. 1, the all solid-state battery 100 may include an electrode assembly having a stacked structure of a negative electrode 400 including a negative current collector 401 and a negative electrode layer 403, a solid electrolyte 300, a positive electrode 200 including a positive current collector 201 and a positive active material layer 203, and an elastic sheet 500 positioned on the outside of at least one of the positive electrode 200 and the negative electrode 400. The electrode assembly may be housed in a case, e.g., a pouch or the like. For example, as illustrated in FIG. 1, the elastic sheet 500 may be between (e.g., directly between) an inner sidewall of the case and each of the positive and negative current collectors 201 and 401.

For example, as illustrated in FIG. 1, the all solid-state battery 100 may include one (e.g., a single) electrode assembly including the negative electrode 400, the solid electrolyte 300, and the positive electrode 200. In another example, the all solid-state battery 100 may include at least two stacked electrode assemblies.

The all solid-state battery 100 may be fabricated by pressurizing the electrode assembly during the preparation process. The all solid-state battery 100 may have a structure in which charging and discharging occurs in a pressurized state.

For example, as illustrated in FIG. 1, the elastic sheet 500 may be positioned on the outermost surface of the electrode assembly (e.g., on an outer surface of each of the positive and negative current collectors 201 and 401 facing the case). In another example, if two or more electrode assemblies are stacked on top of each other, the elastic sheet may be positioned on the outermost surface of the stacked electrode assembly structure and/or inside the stacked electrode assembly structure.

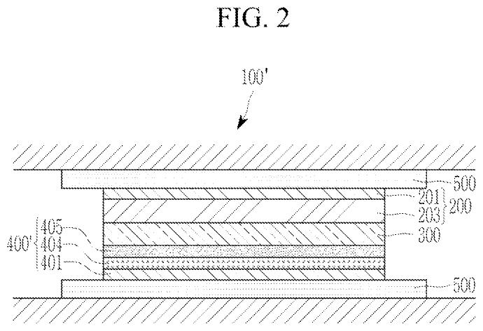

FIG. 2 is a schematic cross-sectional view of an all solid-state battery 100′ including a deposition-type negative electrode. Referring to FIG. 2, a deposition-type negative electrode 400′ may include the negative current collector 401 and a negative active material layer 405 on the negative current collector 401. The all solid-state battery 100′ including such a deposition-type negative electrode 400′ may form a lithium deposition layer 404 by depositing high-density lithium metal or the like between the negative current collector 401 and the negative active material layer 405 during initial charging. This enables the deposition-type negative electrode 400′ to have the negative current collector 401, the lithium deposition layer 404 on the negative current collector 401, and the negative active material layer 405 on the lithium deposition layer 404 in the all solid-state battery 100′ charged once or more. The lithium deposition layer 404 indicates a layer where lithium metal or the like is deposited during charging the battery and may be called a metal layer or a negative active material layer.

Hereinafter, Examples and Comparative Examples are described. The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Preparation of Elastic Sheet

To a composition for an elastic sheet including a 2-ethylhexyl acrylate first monomer, an isobornyl acrylate second monomer, and a 4-hydroxybutyl acrylate third monomer at a weight ratio of 25:25:50, a 1,6-hexanediol diacrylate cross-linking agent and 1,2-diphenyl-2,2-dimethoxyethanone (igacure651 available from Ciba Specialty Chemicals) initiator, acrylonitrile hollow particles (trademark: Expancel 920Det40 available from Nouryon, previously known as AkzoNovel Specialty Chemicals, glass bubble (trademark: K-1 available from 3M Company) and fine powder silica (trademark: R-972 available form Evonik Industries) were added. Based on 100 parts by weight of the composition for the elastic sheet, an amount of the cross-linking agent was 0.05 parts by weight, an amount of the initiator was 0.25 parts by weight, an amount of the hollow particles was 1 part by weight, an amount of the glass bubble was 7 parts by weight, and the fine powder silica was 0.5 parts by weight.

The resulting mixture was coated on a polyethylene terephthalate (PET) film as a release film and was irradiated with ultraviolet (UV) light with a light quantity of 2000 mJ/cm² to prepare an elastic sheet adhered on the PET film. The prepared elastic sheet included a terpolymer of a first repeating unit derived from the first monomer, a second repeating unit derived from the second monomer, and a third repeating unit derived from the third monomer.

### (2) Preparation of Positive Electrode

85 wt % of a LiNi_{0.8}Co_{0.15}Mn_{0.05}O₂ positive active material, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed in an N-methyl pyrrolidone solvent to prepare a positive electrode composition. The prepared positive electrode composition was coated on an aluminum positive current collector using a bar coater and dried followed by pressurizing to prepare a positive electrode.

### (3) Preparation of Solid Electrolyte Layer

To a binder solution in which an acryl binder (SX-A334 available from Zeon Corporation) was dissolved in an isobutyryl isobutyrate (IBIB) solvent, an argyrodite-type solid electrolyte Li₆PS₅Cl (D50=3 μm) was added and it was shaken in a Thinky mixer to adjust a suitable viscosity. 2 mm zirconia ball was added thereto and was again shaken using a Thinky mixer to prepare a slurry. In the prepared slurry, an amount of the solid electrolyte was 98.5 wt % and an amount of the binder was 1.5 wt %.

The slurry was coated on a release polyethylene film using a bar coater and dried at a room temperature (25° C.), and the release polyethylene film was removed to prepare a solid electrolyte layer.

### (4) Preparation of Negative Electrode

Carbon black with an average particle diameter D50 of approximately 30 nm and silver (Ag) with an average particle diameter D50 of approximately 60 nm were mixed at a weight ratio of 3:1, 0.25 g of the resultant mixture was added to 2 g of an N-methyl pyrrolidone solution including 7 wt % of polyvinylidene fluoride binder, and then mixed to prepare a composition for a negative active material layer. The composition for the negative active material layer was coated on a nickel foil current collector using a bar coater and vacuum-dried to prepare a negative electrode.

### (5) Fabrication of all Solid-State Cell

The prepared positive electrode, the solid electrolyte layer, and the negative electrode were sequentially stacked, and then the elastic sheet was stacked on the negative electrode. Thereafter, the negative electrode, the solid electrolyte layer, and the positive electrode were sequentially stacked to prepare an assembly in the order of positive electrode/solid electrolyte/negative electrode/elastic sheet/negative electrode/solid electrolyte/positive electrode.

The resultant assembly was inserted into a laminate film and applied with isostatic pressure of 500 MPa at 80° C. (e.g., isostatically pressed under 500 MPa at 80° C.) to fabricate an all solid-state cell. In the pressurized state, the thickness of the positive active material layer was about 100 μm, the thickness of the negative active material layer was about 7 μm, the thickness of the solid electrolyte layer was about 60 μm, and the thickness of the elastic sheet was about 120 μm.

### Example 2

An elastic sheet was prepared by the same procedure as in Example 1, except that a composition for the elastic sheet included a mixture of a 2-ethylhexyl acrylate first monomer, an isobornyl acrylate second monomer, and a 4-hydroxybutyl acrylate third monomer at a weight ratio 35:15:50. Using the elastic sheet, an all solid-state cell was fabricated by the same procedure as in Example 1.

### Example 3

An elastic sheet was prepared by the same procedure as in Example 1, except that an amount of the acrylonitrile hollow particles was 0.5 parts by weight based on 100 parts by weight of the composition for the elastic sheet. Using the elastic sheet, an all solid-state cell was fabricated by the same procedure as in Example 1.

### Example 4

An elastic sheet was prepared by the same procedure as in Example 1, except that an amount of the acrylonitrile hollow particles was 3 parts by weight based on 100 parts by weight of the composition for the elastic sheet. Using the elastic sheet, an all solid-state cell was fabricated by the same procedure as in Example 1.

### Example 5

An elastic sheet was prepared by the same procedure as in Example 1, except that an amount of the glass bubble was 3 parts by weight based on 100 parts by weight of the composition for the elastic sheet. Using the elastic sheet, an all solid-state cell was fabricated by the same procedure as in Example 1.

### Example 6

An elastic sheet was prepared by the same procedure as in Example 1, except that an amount of the glass bubble was 10 parts by weight based on 100 parts by weight of the composition for the elastic sheet. Using the elastic sheet, an all solid-state cell was fabricated by the same procedure as in Example 1.

### Comparative Example 1

An elastic sheet was prepared by the same procedure as in Example 1, except that the acrylonitrile hollow particles were not added. Using the elastic sheet, an all solid-state cell was fabricated by the same procedure as in Example 1.

### Comparative Example 2

An elastic sheet was prepared by the same procedure as in Example 1, except that the glass bubble was not added. Using the elastic sheet, an all solid-state cell was fabricated by the same procedure as in Example 1.

### Comparative Example 3

An all solid-state cell was fabricated by the same procedure as in Comparative Example 1, except that a (premade) urethane film with a thickness of 200 μm prepared by using polyurethane resin with an excellent recovery ratio was used as an elastic sheet.

### Comparative Example 4

An all solid-state cell was fabricated by the same procedure as in Comparative Example 1, except that a (premade) urethane film with a thickness of 200 μm prepared by using polyurethane resin with excellent stress relaxation characteristics was used as an elastic sheet.

### Experimental Example 1: Evaluation of Compressive Strength

The compressive strength of the elastic sheets according to Examples 1 to 6 and Comparative Examples 1 to 4 were measured. The compressive strength was the values of CFD50 and CFD70, which refers to the compressive strength when the elastic sheet was physically compressed to 50% and 30%, respectively, relative to the original thickness.

The compression process was carried out by compressing a specimen at a compression ratio of 0.6 mm/min (10 μm/sec) using a compression tester equipped with a spherical jig with a diameter of 10 mm. The compressive strength was obtained when the thickness was reached to 50% and 30% of the specimen thickness. The results are shown in Table 1, below.

### Experimental Example 2: Evaluation of Stress Relaxation Ratio

The stress relaxation ratios for the elastic sheets of Examples 1 to 6 and Comparative Examples 1 to 4 was evaluated. The results are shown in Table 1, below. The stress relaxation ratio was measured by primarily compressing the elastic sheet under a pressurization condition of 2.5 kgf, immediately secondarily compressing it at 40 μm to measure initial stress, and maintaining it for 60 seconds after secondary compression to measure stress calculated using Equation 2.

Stress relaxation ratio (%)=(Stress after60 seconds after40 μm compression)/(initial stress at 40 μm)×100 Equation 2

### Experimental Example 3: Evaluation of Recovery Ratio

The recovery ratios for the elastic sheet of Examples 1 to 6 and Comparative Examples 1 to 4 were evaluated. The recovery ratio was measured by primarily compressing the elastic sheet under a pressurization condition of 2.5 kgf, immediately secondarily compressing it at 40 μm, and maintaining it for 60 seconds to measure the initial stress at the time of the first compression and the stress at the time of returning to the secondary starting point (initial point) to calculate it according to Equation 3.

Recovery ratio (%)=(Stress at the time of restoration to initial point after40 μm)/(Initial stress at 40 μm compression)×100 [Equation 3]

The components of the elastic sheet according to Examples 1 to 6 and Comparative Examples 1 to 4 are shown in Table 1, below. In Table 1, a thickness ratio is a ratio of a thickness of an acryl resin first layer to a thickness of (urethane resin second layer+third layer).

### Experimental Example 4: Evaluation of Cycle-Life

The all solid-state cells of Examples 1 to 6 and Comparative Examples 1 to 4 were inserted into a test module and fixed with a force of 5000 gf, and then charged at a constant current of 0.1 C at 45° C. to the upper voltage limit of 4.25 V and discharged at 0.1 C to the cut-off voltage of 2.5 V to perform initial charge and discharge.

The cells initial charged and discharged were charged and discharged at 0.33 C in the voltage range of 2.5 V to 4.25 V at 45° C. for 300 cycles, and the number of cycles at which the discharge capacity relative to the initial discharge capacity was dropped to less than 90% was considered as the cycle-life. The results are shown in Table 1, below.

TABLE 1

| | | Stress | | |
|---|---|---|---|---|
| | | relaxation | Recovery | Cycle-life |
| | CFD70/CFD50 | ratio (%) | ratio (%) | (Cycles) |
| Example 1 | 2.513/1.062 = 2.37 | 10.4 | 73.3 | >300 |
| Example 2 | 3.527/1.532 = 2.30 | 9.1% | 80.1% | >300 |
| Example 3 | 3.015/1.133 = 2.67 | 9.0% | 80.9% | >300 |
| Example 4 | 2.059/0.918 = 2.24 | 13.8% | 74.2% | >300 |
| Example 5 | 2.213/0.950 = 2.33 | 12.5% | 67.0% | >300 |
| Example 6 | 4.447/1.804 = 2.47 | 10.4% | 73.3% | >300 |
| Comparative | 3.080/1.184 = 2.60 | 1.5 | 91.7 | −100 |
| Example 1 | | | | |
| Comparative | 1.022/0.568 = 1.8 | 11.3 | 70.5 | −190 |
| Example 2 | | | | |
| Comparative | 12.747/2.082 = 6.12 | 14.8 | 72.4 | −70 |
| Example 3 | | | | |
| Comparative | 4.911/1.119 = 4.39 | 12.8 | 66.4 | −220 |
| Example 4 | | | | |

As shown in Table 1, the all solid-state cells according to Examples 1 to 5 including the clastic sheet including the acryl binder, the hollow particles, and the glass filler and satisfy the condition of Equation 1, exhibited excellent stress relaxation ratio, recovery ratio, and cycle-life characteristic. Whereas Comparative Example 1 (without the hollow particles) exhibited significantly low stress relaxation ratio and low cycle-life characteristic, and Comparative Example 2 (without the glass bubble) exhibited low stress relaxation ratio and recovery ration, and poor cycle-life characteristics. Further, Comparative Examples 3 and 4 (using the urethane elastic sheet) exhibited low recovery ratio and cycle-life characteristics.

By way of summation and review, one or more embodiments provide an elastic sheet for an all solid-state battery maintaining low compressive strength during compression by charging and discharging and reducing strength (e.g., stress) applied to the solid electrolyte, and thus, improving the cycle-life characteristics. One or more embodiments also provide an all solid-state battery including the elastic sheet.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all solid-state battery, the elastic sheet comprising:
an acryl binder;
hollow particles; and
a glass filler,
wherein the elastic sheet satisfies Equation 1,
$$2 \leq CFD 70 / CFD 50 \leq 4 \qquad [ Equation 1 ]$$
wherein, in Equation 1, CFD50 is a compressive strength (MPa) measured at a point of about 50% of an initial thickness of the elastic sheet, and CFD70 is a compressive strength (MPa) measured at a point of about 30% of the initial thickness of the elastic sheet.

2. The elastic sheet for an all solid-state battery as claimed in claim 1, wherein the CFD50 equals about 0.5 MPa to about 4 MPa.

3. The elastic sheet for an all solid-state battery as claimed in claim 1, wherein the CFD70 equals about 2 MPa to about 6 MPa.

4. The elastic sheet for an all solid-state battery as claimed in claim 1, wherein when the CFD70 and the CFD50 are set to a y-axis and a strain rate of the elastic sheet is set to an x-axis, a slope is about 4 to about 30.

5. The elastic sheet for an all solid-state battery as claimed in claim 1, wherein an amount of the acryl binder is about 85 wt % to 98.5 wt %, based on 100 wt % of the elastic sheet.

6. The elastic sheet for an all solid-state battery as claimed in claim 1, wherein an amount of the hollow particles is about 0.5 wt % to about 5 wt %, based on 100 wt % of the elastic sheet.

7. The elastic sheet for an all solid-state battery as claimed in claim 1, wherein an amount of the glass filler is about 1 wt % to about 10 wt %, based on 100 wt % of the elastic sheet.

8. The elastic sheet for an all solid-state battery as claimed in claim 1, wherein the acryl binder is a (meth)acryl copolymer.

9. The elastic sheet for an all solid-state battery as claimed in claim 8, wherein the (meth)acryl copolymer is a terpolymer comprising a first repeating unit derived from a linear alkyl (meth)acrylate having a glass transition temperature of about −30° C. or less, a second repeating unit derived from cyclic alkyl (meth)acrylate having a Tg of about 50° C. or more, and a third repeating unit derived from alkyl (meth)acrylate having a hydroxy group.

10. The elastic sheet for an all solid-state battery as claimed in claim 9, wherein the terpolymer comprises the first repeating unit in an amount of about 10 wt % to about 40 wt %, the second repeating unit in an amount of about 20 wt % to about 50 wt %, and the third repeating unit in an amount of about 10 wt % to about 50 wt %, based on 100 wt % of the terpolymer.

11. The elastic sheet for an all solid-state battery as claimed in claim 1, wherein the hollow particles are polymer hollow particles.

12. The elastic sheet for an all solid-state battery as claimed in claim 11, wherein the polymer hollow particles comprise polyacrylonitrile, a polymethylmethacrylate polymer, a silicon-containing polymer, or a combination thereof.

13. The elastic sheet for an all solid-state battery as claimed in claim 1, wherein each of the hollow particles has a diameter of about 10 μm to about 90 μm.

14. The elastic sheet for an all solid-state battery as claimed in claim 1, wherein the glass filler has a particle diameter of about 10 μm to about 90 μm.

15. An all solid-state battery, comprising:
a positive electrode;
a negative electrode;
a solid electrolyte between the positive electrode and the negative electrode; and
the elastic sheet as claimed in claim 1, the elastic sheet being positioned outside of at least one of the positive electrode and the negative electrode.
